SEQUENCE LISTING (11 sequences)

SEQ ID NO: 1 - DNA, 71 bp, synthetic construct
  source 1..71: mol_type = other DNA; note = DNA aptamer specifically binding to SARS-CoV-2
acagcaccacagaccacggcggaggtgtgtttttgggtggctgtggggcgtgttggtgtttgtcttcctgc

SEQ ID NO: 2 - DNA, 72 bp, synthetic construct
  source 1..72: mol_type = other DNA; note = DNA aptamer specifically binding to influenza A virus
ggcaggaagacaaacagccagcgtgacagcgacgcgtagggaccggcatccgcgggtggtctgtggtgctgt

SEQ ID NO: 3 - DNA, 72 bp, synthetic construct
  source 1..72: mol_type = other DNA; note = DNA aptamer specifically binding to influenza B virus
acagcaccacagaccacccgcggatgccggtccctacgcgtcgctgtcacgctggctgtttgtcttcctgcc

SEQ ID NO: 4 - DNA, 26 bp, synthetic construct
  source 1..26: mol_type = other DNA; note = Reverse primer for detection of E gene of SARS-CoV-2
acaggtacgttaatagttaatagcgt

SEQ ID NO: 5 - DNA, 22 bp, synthetic construct
  source 1..22: mol_type = other DNA; note = Forward primer for detection of E gene of SARS-CoV-2
atattgcagcagtacgcacaca

SEQ ID NO: 6 - DNA, 22 bp, synthetic construct
  source 1..22: mol_type = other DNA; note = Reverse primer for detection of RdRp gene of SARS-CoV-2
acaccgtttctatagattagct

SEQ ID NO: 7 - DNA, 21 bp, synthetic construct
  source 1..21: mol_type = other DNA; note = Forward primer for detection of RdRp gene of SARS-CoV-2
ggcaattttgttaccatcagt

SEQ ID NO: 8 - DNA, 23 bp, synthetic construct
  source 1..23: mol_type = other DNA; note = Reverse primer for detection of H1N1 gene of influenza A virus
gcacggtcagcacttatyctrag

SEQ ID NO: 9 - DNA, 23 bp, synthetic construct
  source 1..23: mol_type = other DNA; note = Forward primer for detection of H1N1 gene of influenza A virus
gtgrgctgggttttcatttggtc

SEQ ID NO: 10 - DNA, 23 bp, synthetic construct
  source 1..23: mol_type = other DNA; note = Reverse primer for detection of M gene of influenza B virus
gagacacaattgcctacctgctt

SEQ ID NO: 11 - DNA, 20 bp, synthetic construct
  source 1..20: mol_type = other DNA; note = Forward primer for detection of M gene of influenza B virus
ttctttcccaccgaaccaac

(19) United States
(12) Patent Application Publication
(10) Pub. No.: US 2025/0050339 A1
(43) Pub. Date: Feb. 13, 2025

(54) MULTIPLEX SYSTEM FOR SIMULTANEOUSLY DETECTING MULTIPLE VIRUSES

(71) Applicant: National Tsing Hua University, Hsinchu City (TW)

(72) Inventors: Gwo-Bin LEE, Hsinchu City (TW); Chien-Hsin CHIU, Hsinchu City (TW); Chih-Hung WANG, Hsinchu City (TW)

(73) Assignee: National Tsing Hua University, Hsinchu City (TW)

(21) Appl. No.: 18/485,832

(22) Filed: Oct. 12, 2023

(30) Foreign Application Priority Data
Aug. 8, 2023 (TW) 112129780

(51) Int. Cl. B01L 3/00; B01L 7/00

(52) U.S. Cl. CPC B01L 3/502761; B01L 3/502753; B01L 7/52; B01L 2400/043; B01L 2400/0487

(57) ABSTRACT

A system includes a control module and a microfluidics chip. The control module includes electromagnets. The microfluidics chip includes two bead sets, a substrate, a channel layer disposed on the substrate, and a flow-control layer disposed on the channel layer. The channel layer has a central recess, channels in communication with the central recess, and cavities in communication with the channels. The flow-control layer has through holes aligned with the cavities of the channel layer. The through holes and the cavities cooperatively form wells. The flow-control layer includes micro-valves corresponding in position to the channels, and magnetic components connected to the micro-valves. A sample is disposed in one of the wells, and the bead sets are coated with aptamers and attach to another two of the wells. The electromagnets control the micro-valves to allow flow of the sample and to allow the sample to be mixed with the bead sets.

### CROSS-REFERENCE TO RELATED APPLICATION

This application claims priority to Taiwanese Invention patent application No. 112129780, filed on Aug. 8, 2023, and incorporated by reference herein in its entirety.

### SEQUENCE LISTING XML

The Sequence Listing submitted concurrently herewith with a file name of “PE-68714-AM-SEQUENCE LISTING.xml,” a creation date of Oct. 3, 2023, and a size of 13.0 kilobytes, is part of the specification and is incorporated by reference in its entirety.

### FIELD

The disclosure relates to a microfluidics device, and more particularly to a multiplex system for simultaneously detecting at least two specific viruses possibly contained in a sample.

### BACKGROUND

Techniques widely utilized in virus detection include viral separation, immunofluorescence, enzyme-linked immunosorbent assay (ELISA), polymerase chain reaction (PCR) and lateral flow immunoassay (LFIA).

Referring to FIG. 1, Chinese Invention Patent Publication No. 109988869 A discloses a conventional virus detection device 9. The conventional detection device 9 includes a microfluidic chip 91 and a magnetic field generator (not shown). The microfluidic chip 91 has a heater (not shown), a processing pool 911, a particle reservoir 912, a wash reservoir 913 for receiving washing liquid, four reaction reservoirs 914, a liquid reservoir 915 for receiving solvent, a plurality of micro-channels 916, and a plurality of micro-valves 917 respectively disposed on the micro-channels 916. The processing pool 911 receives a sample that may be obtained from a throat swab or a nasopharyngeal aspirate. The particle reservoir 912 receives magnetic particles that have silicyl surfaces and that are used for absorbing various respiratory viruses. The reaction reservoirs 914 respectively receive four different nucleic acid compositions, and each of the reaction reservoirs 914 further receives the same PCR reaction reagent. The magnetic field generator creates a magnetic field for exerting a magnetic force on a desired group of micro-valves 917 to make the desired group of micro-valves 917 operate in an open state, so as to allow the sample to flow from the processing pool 911 to the reaction reservoirs 914 through the micro-channels 916 and then mixed with the detection component. The heater functions by controlling temperature during PCR. In this way, respiratory viruses possibly contained in the sample may be detected. It should be noted that the magnetic particles contained in the detection component is not specific for absorbing a specific virus, so virus detection using the conventional detection device 9 may be inaccurate. Moreover, the conventional detection device 9 is non-reusable.

### SUMMARY

Therefore, an object of the disclosure is to provide a multiplex system for simultaneously detecting at least two specific viruses possibly contained in a sample that can alleviate at least one of the drawbacks of the prior art.

According to the disclosure, the multiplex system includes a control module and a microfluidics chip.

The control module includes an electromagnet array that is configured to create a magnetic field.

The microfluidics chip includes a substrate, a liquid channel layer, a flow-control layer and at least two bead sets.

The substrate is disposed on the control module.

The liquid channel layer is disposed on the substrate and has at least one channel unit. The channel unit has a central recess portion and a plurality of microfluidics portions that extend radially from the central recess portion. Each of the microfluidics portions has a channel that is in spatial communication with the central recess portion and that extends radially from the central recess portion, and a cavity that is in spatial communication with the channel and that is opposite to the central recess portion.

The flow-control layer is disposed on the liquid channel layer. The flow-control layer has a plurality of upper through holes that are respectively aligned with the cavities of the liquid channel layer, a plurality of micro-valves that respectively correspond in position to the channels respectively of the microfluidics portions, and a plurality of magnetic components that are respectively connected to the micro-valves. Each of the micro-valves is switchable between a closed state where the micro-valve blocks the corresponding one of the channels, and an open state where the micro-valve allows fluid to flow from a corresponding one of the cavities to the central recess portion through the corresponding one of the channels. Each of the upper through holes and the corresponding one of the cavities cooperatively form a well.

The at least two bead sets are respectively disposed in at least two of the wells respectively formed by the cavities. Each of the at least two bead sets includes a plurality of beads that are configured to be magnetically attracted to the electromagnet array such that the beads attach to the corresponding one of the wells and that are to be coated with the same aptamer for binding a target molecule of one of said at least two specific viruses possibly in the sample.

At least one of those of the wells that do not receive the at least two bead sets is configured to receive the sample.

The electromagnet array is configured to create a magnetic field for exerting a magnetic force on a desired group of the magnetic components such that the corresponding ones of the micro-valves are switched to the open state, so as to allow the sample to flow from the at least one of the wells, in which the sample is received, to the at least two of the wells, in which the at least two bead sets are disposed, and to allow the sample to be mixed with said at least two bead sets.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view of a microfluidic chip of a conventional virus detection device according to Chinese Invention Patent Publication No. 109988869 A.

FIG. 2 is a block diagram of a control module of a multiplex system for simultaneously detecting at least two specific viruses possibly contained in a sample according to an embodiment of the disclosure.

FIG. 3 is an exploded perspective view illustrating a microfluidics chip of the multiplex system according to an embodiment of the disclosure.

FIG. 4 is a top view of the microfluidics chip according to the embodiment of the disclosure.

FIGS. 5 and 6 are schematic diagrams cooperatively illustrating the multiplex system according to the embodiment of the disclosure.

FIGS. 7 to 12 are schematic diagrams cooperatively illustrating an example of operation of the multiplex system according to the embodiment of the disclosure.

FIG. 13 is a flow chart illustrating a method for operating the multiplex system according to an embodiment of the disclosure.

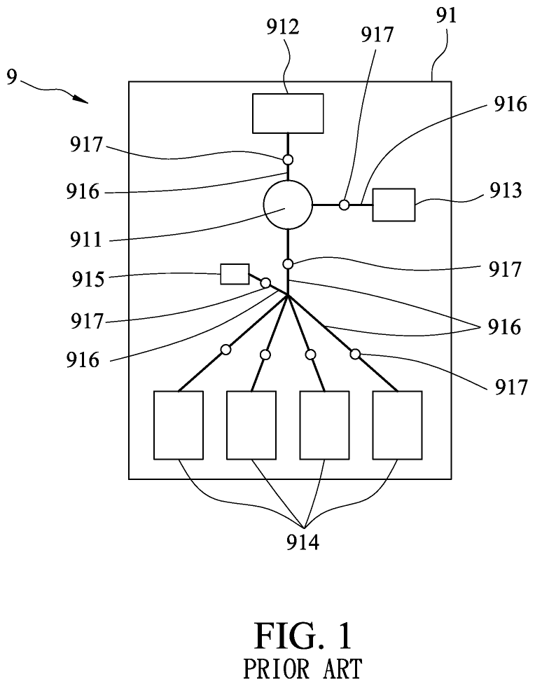

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

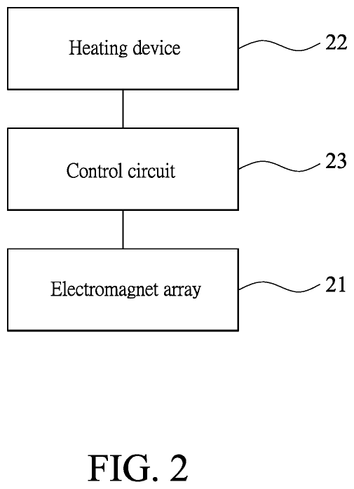

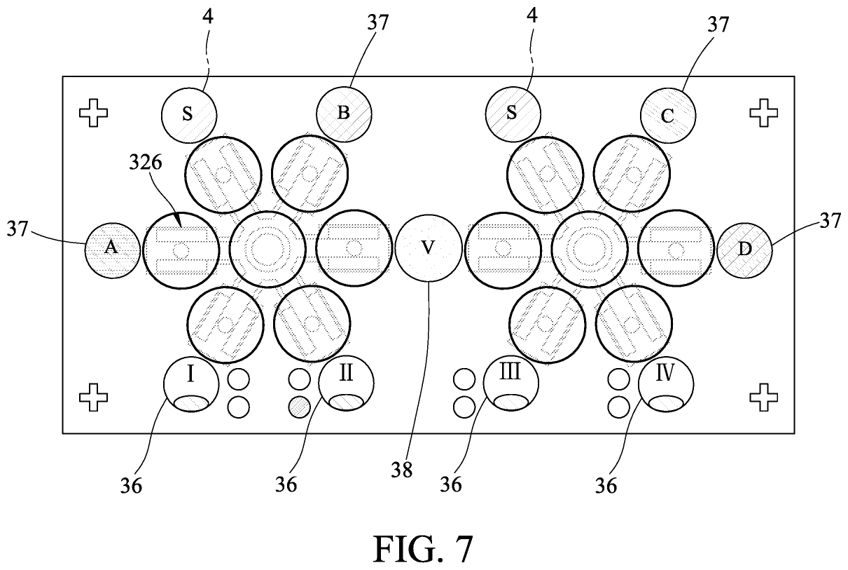

FIGS. 2 to 5 illustrate an embodiment of a multiplex system 1 for simultaneously detecting at least two specific viruses possibly contained in a sample 4 (see FIG. 7) according to the disclosure. Each of the at least two specific viruses is exemplarily one of severe acute respiratory syndrome-coronavirus 2 (SARS-COV-2), influenza A virus and influenza B virus. The sample 4 is obtained from tissues or cells of an organism (e.g., a human), and may be a blood sample, a plasma sample, a serum sample, a corneal tissue sample, a tear sample, a saliva sample, a cerebrospinal fluid sample, a feces sample, a tissue biopsy, a surgical specimen, a urine sample, or a fine needle aspirate.

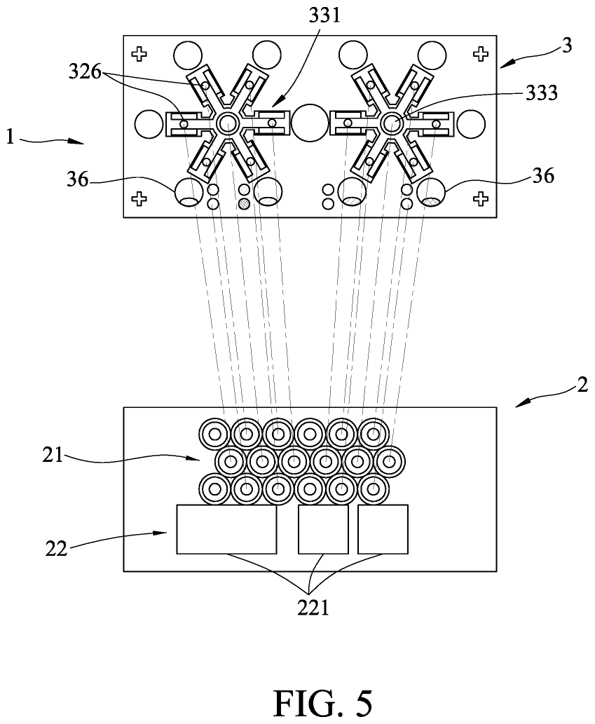

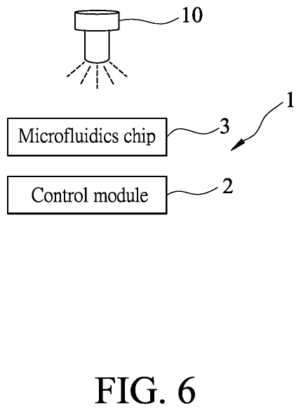

As shown in FIGS. 5 and 6, the multiplex system 1 includes a control module 2, a microfluidics chip 3 disposed on the control module 2, and a light detector 10 disposed above the microfluidics chip 3.

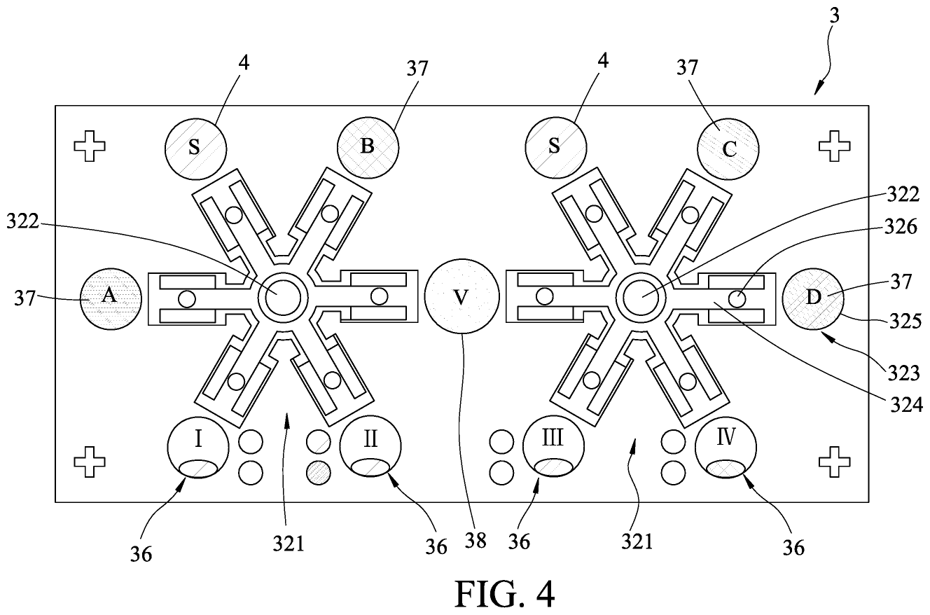

Further referring to FIG. 2, the control module 2 includes an electromagnet array 21, a heating device 22, and a control circuit 23. The electromagnet array 21 is configured to create a magnetic field, and includes 18 electromagnets that are arranged in an array of six columns by three rows as shown in FIG. 4. In some embodiments, each of the electromagnets of the electromagnet array 21 is substantially shaped in a long strip. The heating device 22 is adjacent to the electromagnet array 21, and is configured to perform thermal lysis to break viral envelopes of the at least two specific viruses possibly contained in the sample 4 so as to release viral RNAs from the at least two specific viruses. In this embodiment, the heating device 22 includes three heating modules 221 each including a thermoelectric cooler (e.g., TEC1-241.10 purchased from TANDE ENERGY AND TEMPERATURE ASSOCIATES PTY. CO., Taiwan), a copper plate (obtained from Scientific Instrument Center of National Tsing Hua University in Taiwan) having a thickness of 10 mm, a temperature sensor (e.g., Max6675 obtained from CENTENARY MATERIALS CO., LTD., Taiwan), and a relay (purchased from CENTENARY MATERIALS CO., LTD., Taiwan). The control circuit 23 is electrically connected to the electromagnet array 21 and the heating device 22, and is configured to control operations of the electromagnet array 21 and the heating device 22. In this embodiment, the control circuit 23 is implemented by fourteen L298N dual full bridge drivers manufactured by STMicroelectronics company, an Arduino Mega 2560 (Rev3) microcontroller, and a CPS-3205 II power supply (purchased from CENTENARY MATERIALS CO., LTD., Taiwan).

For portability and reusability, the microfluidics chip 3 has a dimension of 45 mm×95 mm. However, the dimension of the microfluidics chip 3 may vary according to practical needs.

The microfluidics chip 3 includes a substrate 31, a liquid channel layer 32, a flow-control layer 33 and at least two bead sets 36. The substrate 31 is made of glass, and each of the liquid channel layer 32 and the flow-control layer 33 is made of polydimethylsiloxane (PDMS). However, material of each of the substrate 31, the liquid channel layer 32 and the flow-control layer 33 may vary according to practical needs and is not limited to the disclosure herein.

The substrate 31 is disposed on the control module 2.

The liquid channel layer 32 is disposed on the substrate 31. The liquid channel layer 32 has at least one channel unit 321. The channel unit 321 has a central recess portion 322, and a plurality of microfluidics portions 323 that extend radially from the central recess portion 322. Each of the microfluidics portions 323 has a channel 324 and a cavity 325. The channel 324 is in spatial communication with the central recess portion 322 and extends radially from the central recess portion 322. The cavity 325 is in spatial communication with the channel 324 and is opposite to the central recess portion 322.

The flow-control layer 33 is disposed on the liquid channel layer 32. The flow-control layer 33 has a plurality of upper through holes 332 that are respectively aligned with the cavities 325 of the liquid channel layer 32, a plurality of micro-valves 333 that respectively correspond in position to the channels 324 respectively of the microfluidics portions 323, and a plurality of magnetic components 331 that are respectively connected to the micro-valves 333. Each of the micro-valves 333 is switchable between a closed state where the micro-valve 333 blocks the corresponding one of the channels 324, and an open state where the micro-valve 333 allows fluid to flow from the corresponding one of the cavities 325 to the central recess portion 322 through the corresponding one of the channels 324. Each of the magnetic components 331 is a permanent magnet. The electromagnet array 21 is configured to create a magnetic field for exerting a pulling force on one of the magnetic components 331 such that the corresponding one of the micro-valves 333 is switched to the closed state when the control circuit 23 of the control module 2 supplies the electromagnet array 21 with a positive voltage, and to create a magnetic field for exerting a pushing force on one of the magnetic components 331 such that the corresponding one of the micro-valves 333 is switched to the open state when the control circuit 23 of the control module 2 supplies the electromagnet array 21 with a negative voltage. Each of the upper through holes 332 and the corresponding one of the cavities 325 cooperatively form a well.

In one embodiment, the microfluidics chip 3 further includes a connecting layer 35. The connecting layer 35 is disposed between the liquid channel layer 32 and the flow-control layer 33. The connecting layer 35 is a double-sided tape that is configured to connect the flow-control layer 33 and the liquid channel layer 32. The connecting layer 35 is formed with a plurality of lower through holes 351 respectively corresponding to the cavities 325 of the liquid channel layer 32 in position. Each of the lower through holes 351, the corresponding one of the upper through holes 332 and the corresponding one of the cavities 325 cooperatively form one of the wells.

In one embodiment, each of the microfluidics portions 323 further has a groove 326 formed in the liquid channel 324. Each of the micro-valves 333 is disposed between the corresponding one of the magnetic components 331 and the liquid channel layer 32, and is fittingly disposed in the groove 326 in the corresponding one of the channels 324 when the micro-valve 333 is in the closed state.

In one embodiment, the flow-control layer 33 further includes a micro-pump 334 corresponding in position to the central recess portion 322 of the channel unit 321 of the liquid channel layer 32, and another magnetic component 331 connected to the micro-pump 334. The micro-pump 334 is disposed between said another magnetic component 331 and the liquid channel layer 32. The electromagnet array 21 is further configured to create a magnetic field for exerting a magnetic force on said another magnetic component 331 such that the micro-pump 334 reciprocate for driving flow of the sample 4.

The at least two bead sets 36 are respectively disposed in at least two of the wells respectively formed by the cavities 325. At least one of those of the wells that do not receive the at least two bead sets 36 is configured to receive the sample 4. Each of the at least two bead sets 36 includes a plurality of beads that are configured to be magnetically attracted to the electromagnet array such that the beads attach to the corresponding one of the wells, and that are coated with the same aptamer for specifically binding a target molecule of one of the at least two specific viruses possibly in the sample 4. The beads are made of magnetic material such as iron, but is not limited thereto, and the magnetic material for making the beads may vary in other embodiments. It is worth to note that an aptamer is a single-stranded DNA (ssDNA) or a single-stranded RNA (ssRNA) having a nucleic acid tertiary structure, and is obtained using techniques such as systematic evolution of ligands by exponential enrichment (SELEX). The aptamer is capable of specifically binding a target such as a small molecule, a biomacromolecule, an infected cell, a stem cell or a cancer cell.

TABLE 1

| | | Nucleotide sequence |
|---|---|---|
| Aptamer | Target | (5′→3′) |
| SEQ ID | SARS-CoV-2 | acagcaccacagaccacggcgg |
| NO: 1 | | aggtgtgtttttgggtggctgt |
| | | ggggcgtgttggtgtttgtctt |
| | | cctgc |
| SEQ ID | Influenza A | ggcaggaagacaaacagccagc |
| NO: 2 | virus | gtgacagcgacgcgtagggacc |
| | | ggcatccgcgggtggtctgtgg |
| | | tgctgt |
| SEQ ID | Influenza B | acagcaccacagaccacccgcg |
| NO: 3 | virus | gatgccggtccctacgcgtcgc |
| | | tgtcacgctggctgtttgtctt |
| | | cctgcc |

In one embodiment, the beads of one of the at least two bead sets 36 are coated with a DNA aptamer of SEQ ID NO: 1 (see Table 1) such that the beads are capable of specifically binding to the spike protein of severe acute respiratory syndrome-coronavirus 2 (SARS-COV-2). The procedures and conditions for design of the DNA aptamer may be adjusted according to practical requirements. In this regard, those skilled in the art may refer to journal articles, e.g., Kacherovsky et al. (2021), Angewandte Chemie., 133:21381-21385.

In one embodiment, the beads of one of the at least two bead sets 36 are coated with a DNA aptamer of SEQ ID NO: 2 (see Table 1) such that the beads are capable of specifically binding to the target molecule of influenza A virus. The procedures and conditions for design of the DNA aptamer may be adjusted according to practical requirements. In this regard, those skilled in the art may refer to journal articles, e.g., Shen et al. (2019), Royal society of chemistry., 19:1277-1286.

In one embodiment, the beads of one of the at least two bead sets 36 are coated with a DNA aptamer of SEQ ID NO: 3 (see Table 1) such that the beads are capable of specifically binding to the target molecule of influenza B virus. The procedures and conditions for design of the DNA aptamer may be adjusted according to practical requirements. In this regard, those skilled in the art may refer to journal articles, e.g., Wagn CH. et al. (2016), Biosens Bioelectron., 86:247-254.

The electromagnet array 21 is configured to create a magnetic field for exerting a magnetic force on a desired group of the magnetic components 331 such that the corresponding ones of the micro-valves 333 are switched to the open state, so as to allow the sample 4 to flow from the at least one of the wells, in which the sample 4 is received, to the at least two of the wells, in which the at least two bead sets 36 are disposed, and to allow the sample 4 to be mixed respectively with the at least two bead sets 36.

One of those of the wells that do not receive the at least two bead sets 36 and the sample 4 is configured to receive a cleaning substance 38 (see FIG. 6) so that the cleaning substance 38 washes away residues of the sample 4 that is not bound by the at least two bead sets 36. In particular, the cleaning substance 38 is double distilled water (ddH₂O).

Moreover, at least two of those of the wells that do not receive the at least two bead sets 36 and the sample 4 are configured to respectively receive at least two assay reagents 37 such that existence of the at least two specific viruses in the sample 4, respectively, can be detected. Each of the at least two assay reagents 37 is a reagent of reverse transcription polymerase chain reaction (RT-PCR) assay, and is capable of reacting with viral RNAs possibly in the sample 4 during RT-PCT conducted under temperature control by the heating device 22. Each of the at least two assay reagents 37 contains fluorescent dye, and when one of the at least two specific viruses in the sample 4 is detected during RT-PCR, the fluorescent dye emits fluorescent light that corresponds to the one of the at least two specific viruses and that has an intensity related to an amount of the one of the at least two specific viruses. To be specific, the fluorescent dye is KAPA SYBR® FAST qPCR Master Mix (2×) Kit purchased from KAPA BIOSYSTEMS, South Africa.

The light detector 10 is configured to detect the fluorescent light emitted by the fluorescent dye, and to output, based on the intensity of the fluorescent light thus detected, a result indicating the amount of the one of the at least two specific viruses. It is worth to note that the light detector 10 may include a light-emitting diode (LED, which is produced by Everlight Electronics., Ltd, Taiwan) that is configured to emit light having a wavelength of 485 nm for exciting the fluorescent dye, and a set of silicon photomultipliers (SiPMs, which is produced by First Sensor company, Germany) that is configured to collect the fluorescent light emitted by the fluorescent dye.

TABLE 2

| | | Nucleotide sequence |
|---|---|---|
| Primer | Target | (5′→3′) |
| SEQ ID | SARS-CoV-2 | acaggtacgttaatagttaatagcgt |
| NO: 4 | (E gene) | |
| SEQ ID | | atattgcagcagtacgcacaca |
| NO: 5 | | |
| SEQ ID | SARS-CoV-2 | acaccgtttctatagattagct |
| NO: 6 | (RdRp gene) | |
| SEQ ID | | ggcaattttgttaccatcagt |
| NO: 7 | | |
| SEQ ID | Influenza A | gcacggtcagcacttatyctrag |
| NO: 8 | virus | |
| SEQ ID | (H1N1 gene) | gtgrgctgggttttcatttggtc |
| NO: 9 | | |
| SEQ ID | Influenza B | gagacacaattgcctacctgctt |
| NO: 10 | virus | |
| SEQ ID | (M gene) | ttctttcccaccgaaccaac |
| NO: 11 | | |

Please note that in the nucleotide sequence above, the symbol “r” represents purine that may be guanine (symbol “g”) or adenine (symbol “a”).

In one embodiment, the at least two assay reagents 37 are configured to be used for detecting severe acute respiratory syndrome-coronavirus 2 (SARS-COV-2). As shown in Table 1, one of the at least assay reagents 37 contains primers having nucleotide sequences of SEQ ID NO: 4 and SEQ ID NO: 5 which are used for detecting E gene of SARS-COV-2, and the other one of the at least two assay reagents 37 contains primers having nucleotide sequences of SEQ ID NO: 6 and SEQ ID NO: 7 which are used for detecting RdRp gene of SARS-CoV-2.

In one embodiment, one of the at least two assay reagents 37 is configured to be used for detecting H1N1 gene of influenza A virus, and contains primers having nucleotide sequences of SEQ ID NO: 8 and SEQ ID NO: 9.

In one embodiment, one of the at least two assay reagents 37 is configured to be used for detecting M gene of influenza B virus, and contains primers having nucleotide sequences of SEQ ID NO: 10 and SEQ ID NO: 11.

It is worth to note that in some embodiments, the at least two bead sets 36, the at least two assay reagents 37, the cleaning substance 38 and the sample 4 are disposed in the wells of the microfluidics chip 3 during use of the multiplex system 1 (i.e., not disposed in the wells of the microfluidics chip 3 in advance during fabrication of the multiplex system 1). In some embodiments, the at least two bead sets 36 and the at least two assay reagents 37 are disposed in the wells of the microfluidics chip 3 during fabrication of the microfluidics chip 3 (i.e., disposed in the wells of the microfluidics chip 3 in advance before use of the multiplex system 1).

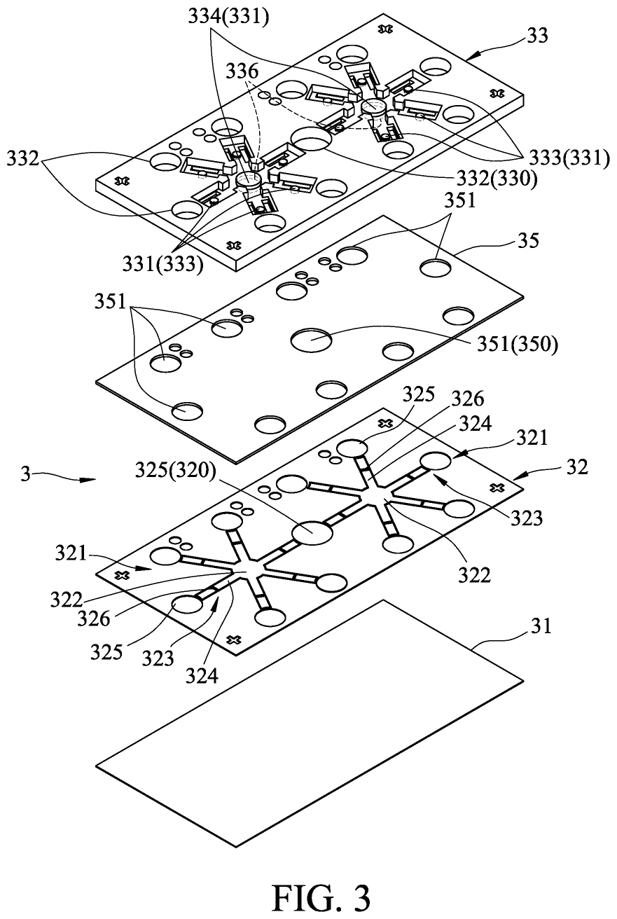

As shown in FIG. 3, in this embodiment, the liquid channel layer 32 has two channel units 321. Each of the channel unit 321 has a central recess portion 322 and six microfluidics portions 323. Two cavities 325 of the two channel units 321, respectively, are in spatial communication with each other, and cooperatively form a central cavity 320 at a center of the liquid channel layer 32. That is to say, one of the cavities 325 of one of the channel units 321 is in spatial communication with a corresponding one of the cavities 325 of the other one of the channel units 321. Similarly, two upper through holes 332 respectively corresponding to the two cavities 325 are in spatial communication with each other, and cooperatively form a central upper through hole 330 at a center of the flow-control layer 33; and two lower through holes 351 respectively corresponding to the two cavities 325 are in spatial communication with each other, and cooperatively form a central lower through hole 350 at a center of the connecting layer 35. In other words, the microfluidics chip 3 has two central recess portions 322 and twelve microfluidics portions 323, and hence the microfluidics chip 3 has twelve channels 324 in total. Since two cavities 325 of the two channel units 321, respectively, overlap and are in spatial communication with each other to cooperatively form the central cavity 320, the microfluidics chip 3 can be considered to have only eleven cavities 325 (including the central cavity 320 formed by two of the cavities 325 that are in spatial communication with each other), eleven upper through holes 332 (including the central upper through hole formed by two of the upper through holes 332 that are in spatial communication with each other), and eleven lower through holes 351 (including the central lower through hole formed by two of the lower through holes 351 that are in spatial communication with each other). Accordingly, the microfluidics chip 3 includes twelve micro-valves 333, two micro-pumps 334, fourteen magnetic components 331 respectively connected to the micro-valves 333 and the micro-pumps 334, and eleven wells each being formed by a respective one of the cavities 325, a corresponding one of the upper through holes 332 and a corresponding one of the lower through holes 351.

As shown in FIG. 4, in this embodiment, four bead sets 36 are respectively disposed in four wells that are positioned in a row and that are respectively denoted with symbols “I”, “II”, “III” and “IV”; four assay reagents 37 are respectively disposed in another four wells that are respectively denoted with symbols “A”, “B”, “C” and “D”; the cleaning substance 38 is disposed in a well that is located at the center of the microfluidics chip 3 and that is denoted with a symbol “V”; and the sample 4 is divided into two portions that are respectively disposed in two wells both denoted with a symbol “S”. Two of the four bead sets 36 are respectively disposed in two wells of one of the two channel units 321, and the other two of the four bead sets 36 are respectively disposed in two wells of the other one of the two channel units 321. Two of the four assay reagents 37 are respectively disposed in two wells of one of the two channel units 321, and the other two of the four assay reagents 37 are respectively disposed in two wells of the other one of the two channel units 321. Specifically, as shown in FIG. 4, when viewed in a counterclockwise direction with respect to the central recess portion 322 of the left one of the channel units 321, the well denoted with symbol “A” receives the assay reagent 37 for detecting E gene of SARS-COV-2, the well denoted with symbol “I” receives the bead set 36 for specific binding to SARS-COV-2, the well denoted with symbol “II” receives another bead set 36 for specific binding to SARS-COV-2, the well denoted with symbol “V” receives the cleaning substance 38, the well denoted with symbol “B” receives the assay reagent 37 for detecting RdRp gene of SARS-COV-2, and the well denoted with symbol “S” receives one portion of the sample 4. Specifically, as shown in FIG. 4, when viewed in a counterclockwise direction with respect to the central recess portion 322 of the right one of the channel units 321, the well denoted with symbol “V” receives the cleaning substance 38, the well denoted with symbol “III” receives the bead set 36 for specific binding to influenza A virus, the well denoted with symbol “IV” receives the bead set 36 for specific binding to influenza B virus, the well denoted with symbol “D” receives the assay reagent 37 for detecting M gene of influenza B virus, the well denoted with symbol “C” receives the assay reagent 37 for detecting H1N1 gene of influenza A virus, and the well denoted with symbol “S” receives the other one portion of the sample 4.

A method for fabricating the microfluidics chip 3 includes steps of: a) casting PDMS in a first poly (methyl methacrylate) (PMMA) mold that has a first predefined pattern; b) keeping the first PMMA mold at a temperature of 80° C. for three hours to solidify PDMS into the liquid channel layer 32; c) taking the PDMS (which is the liquid channel layer 32) from the first PMMA mold; d) arranging twelve micro-valves 333 and two micro-pumps 334 at predefined positions of a second PMMA mold that has a second predefined pattern; e) placing fourteen magnetic components 331 respectively in the twelve micro-valves 333 and the two micro-pumps 334; f) casting PDMS in the second PMMA mold; g) keeping the second PMMA mold at a temperature of 80° C. for three hours to solidify PDMS into the flow-control layer 33; h) taking the PDMS (which is the flow-control layer 33) from the second PMMA mold; i) processing a surface of the liquid channel layer 32 with oxygen plasma for one minute by using a Cute MP/R oxygen-plasma device (obtained from Atlas Technology Corp., Taiwan); j) abutting the substrate 31 that is made of glass against the thus processed surface of the liquid channel layer 32 so as to connect the substrate 31 and the liquid channel layer 32; k) putting the connecting layer 35 on another surface of the liquid channel layer 32 that is opposite to the surface adjacent to the substrate 31; I) placing the flow-control layer 33 on the connecting layer 35 such that the flow-control layer 33 and the liquid channel layer 32 are positioned at opposite sides of the connecting layer 35; and j) disposing four bead sets 36 and four assay reagents 37 in the wells cooperatively formed by the flow-control layer 33, the connecting layer 35 and the liquid channel layer 32 so as to obtain the microfluidics chip 3.

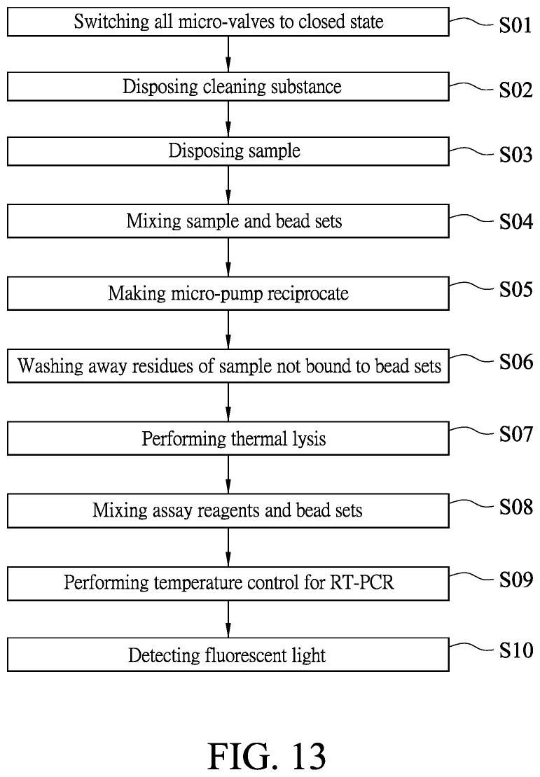

FIG. 13 illustrates an embodiment of an operation method of the multiplex system 1 according to the disclosure. The operation method includes steps S01 to S10 described hereinafter.

In step S01, the electromagnet array 21 is controlled by the control circuit 23 to create a magnetic field such that all of the micro-valves 333 are switched to the closed state.

In step S02, a cleaning substance 38 is disposed in one of those of the wells that do not receive the bead sets 36 and the assay reagents 37.

In step S03, the sample 4 is disposed in one of those of the wells that do not receive the bead sets 36, the assay reagents 37 and the cleaning substance 38.

In step S04, the electromagnet array 21 is controlled by the control circuit 23 to create a magnetic field such that the corresponding ones of the micro-valves 333 are switched to the open state, so as to allow the sample 4 to flow from the one of the wells, in which the sample 4 is received, to those of the wells, in which the bead sets 36 are disposed, and to allow the sample 4 to be respectively mixed with the bead sets 36.

In step S05, the electromagnet array 21 is controlled by the control circuit 23 to create a magnetic field for exerting a magnetic force on said another magnetic component 331 such that the micro-pump 334 reciprocate for driving flow of the sample 4. It is worth to note that the order of step S05 is arbitrary and not limited to the disclosure herein.

In step S06, the electromagnet array 21 is controlled by the control circuit 23 to create a magnetic field such that the corresponding one of the micro-valves 333 are to switched to the open state, so as to allow the cleaning substance 38 to flow from the one of the wells, in which the cleaning substance 38 is received, to the at least two of the wells, in which the at least two bead sets 36 are disposed, so as to wash away residues of the sample 4 that is not bound to the at least two bead sets 36. It is worth to note that the order of step S02 is not limited to the disclosure herein and may vary in other embodiments as long as step S02 is conducted prior to step S06.

In step S07, thermal lysis is conducted using the heating device 22 to break viral envelopes of the at least two specific viruses possibly contained in the sample 4 so as to release viral RNAs of the at least two specific viruses.

In step S08, the electromagnet array 21 is controlled by the control circuit 23 to create a magnetic field such that the corresponding ones of the micro-valves 333 are to switched to the open state to allow the at least two assay reagents 37 to flow from the at least two of the wells, in which the at least two assay reagents 37 are received, to the at least two of the wells, in which the at least two bead sets 36 are disposed, and to allow the at least two assay reagents 37 to be mixed with the viral RNAs that are possibly released.

In step S09, temperature control for RT-PCR is conducted using the heating device 22.

In step S10, the fluorescent light emitted by the fluorescent dye is detected by the light detector 10, and a detection result is outputted, based on intensity of the fluorescent light, by the light detector 10.

FIGS. 7 to 12 illustrate an example of utilization of the embodiment of the multiplex system 1 shown in FIG. 4 to simultaneously detect SARS-COV-2, influenza A virus and influenza B virus.

First, the control circuit 23 of the control module 2 supplies the electromagnet array 21 with a positive voltage for exerting a pulling force on the magnetic components 331 such that all of the micro-valves 333 are switched to the closed state. Moreover, the electromagnet array 21 magnetically attracts the bead sets 36 to the electromagnet array 21 such that the bead sets 36 attach respectively to the wells. Referring to FIG. 7, the well denoted with symbol “I” receives the bead set 36 for specific binding to SARS-COV-2, the well denoted with symbol “II” receives another bead set 36 for specific binding to SARS-COV-2, the well denoted with symbol “III” receives the bead set 36 for specific binding to influenza A virus, the well denoted with symbol “IV” receives the bead set 36 for specific binding to influenza B virus, the well denoted with symbol “A” receives the assay reagent 37 for detecting E gene of SARS-COV-2, the well denoted with symbol “B” receives the assay reagent 37 for detecting RdRp gene of SARS-COV-2, the well denoted with symbol “C” receives the assay reagent 37 for detecting H1N1 gene of influenza A virus, and the well denoted with symbol “D” receives the assay reagent 37 for detecting M gene of influenza B virus.

Subsequently, the cleaning substance 38 is disposed in the well denoted with symbol “V”, and two portions of the sample 4 are respectively disposed in the two wells denoted with symbol “S”.

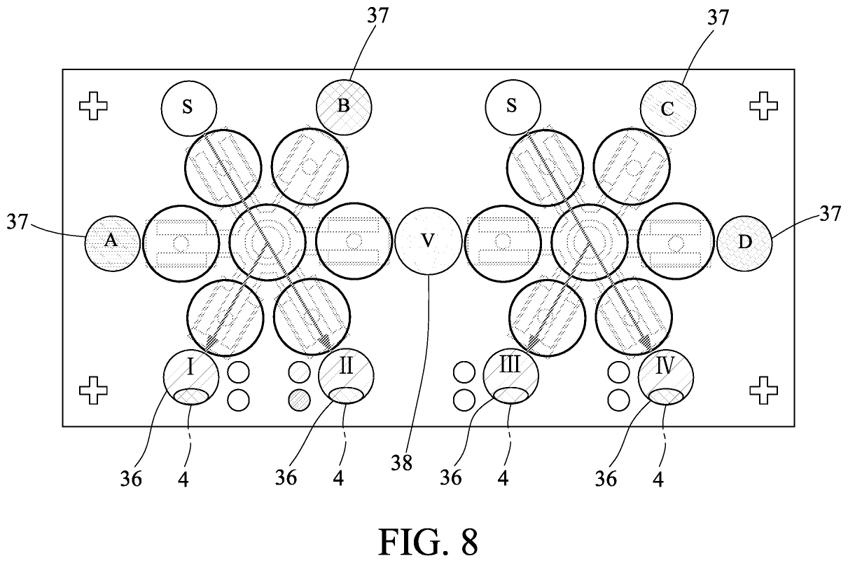

Referring to FIG. 8, the control circuit 23 supplies six electromagnets of the electromagnet array 21 with a negative voltage for exerting a pushing force on six corresponding ones of the magnetic components 331 such that six corresponding ones of the micro-valves 333 (i.e., six micro-valves 333 that respectively correspond to six channels 324 through which solid arrows pass as shown in FIG. 8) are switched to the open state, so as to allow the two portions of the sample 4 to flow (see the solid arrows in FIG. 8) from the two wells denoted with symbol “S” through the central recess portion 322 to four of the wells respectively denoted with symbols “I”, “II”, “III” and “IV” and to allow the sample 4 to be mixed with the beads of the bead sets 36. At the same time, the micro-pump 334 is controlled to reciprocate driving of the flow of the sample 4. In this way, SARS-COV-2, influenza A virus and influenza B virus possibly contained in the sample 4 will be specifically bound to the beads of the bead sets 36.

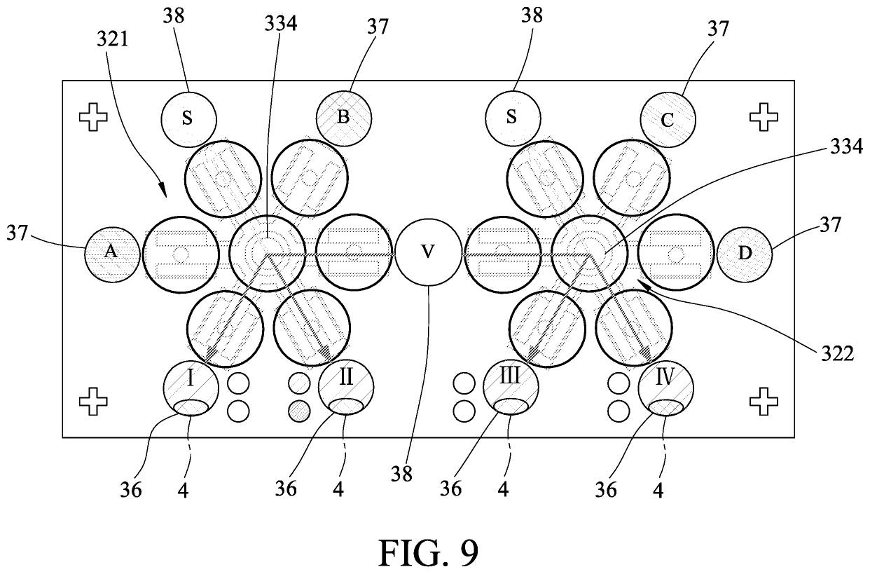

Next, referring to FIG. 9, the control circuit 23 supplies two electromagnets of the electromagnet array 21 with a negative voltage for exerting a pushing force on two corresponding ones of the magnetic components 331 such that two corresponding ones of the micro-valves 333 (i.e., two micro-valves 333 that respectively correspond in position to two channels 324 that are in communication with the well denoted with symbol “V”) are switched to the open state, so as to allow the cleaning substance 38 to flow (see the solid arrows in FIG. 9) from the well denoted with symbol “V” through the central recess portion 322 to four of the wells respectively denoted with symbols “I”, “II”, “III” and “IV” and to allow the cleaning substance 38 to wash away residues of the sample 4 that is not bound to the bead sets 36. At the same time, the micro-pump 334 is controlled to reciprocate driving of flow of the cleaning substance 38. Thereafter, the control circuit 23 supplies the two electromagnets of the electromagnet array 21 with a positive voltage for exerting a pulling force on the two corresponding ones of the magnetic components 331 such that two corresponding ones of the micro-valves 333 (i.e., two micro-valves 333 that respectively correspond in position to two channels 324 that are in communication with the well denoted with symbol “V”) are switched to the closed state, so as to allow the cleaning substance 38 to flow (see dashed arrows in FIG. 9) from the four of the wells respectively denoted with symbols “I”, “II”, “III” and “IV” through the central recess portion 322 to the two wells denoted with symbol “S”.

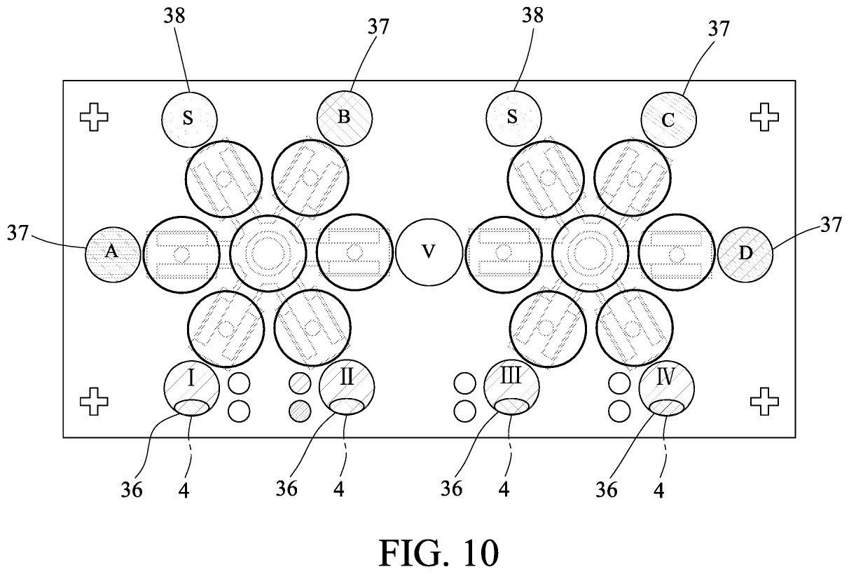

Then, referring to FIG. 10, thermal lysis in the four of the wells respectively denoted with symbols “I”, “II”, “III” and “IV” were conducted using the heating device to break viral envelopes of SARS-COV-2, influenza A virus and influenza B virus possibly bound to the bead sets 26 so as to release viral RNAs of SARS-COV-2, influenza A virus and influenza B virus.

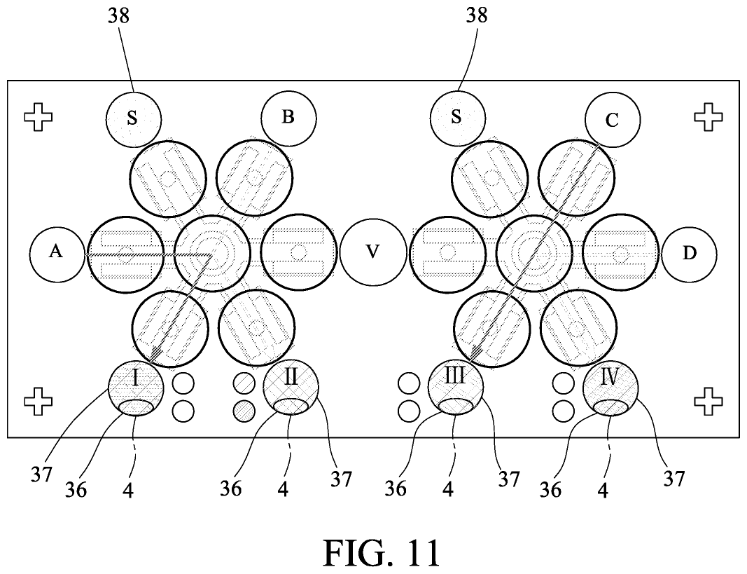

Further, referring to FIG. 11, the control circuit 23 controls two micro-valves 333 respectively correspond in position to two channels 324 that are in communication with two wells respectively denoted with symbols “A” and “I” such that the two micro-valves 333 are switched to the open state and remaining ones of the micro-valves 333 are switched to the closed state, so as to allow the assay reagent 37 for detecting E gene of SARS-COV-2 to flow (see a left one of solid arrows in FIG. 11) from the well denoted with symbol “A” through the central recess portion 322 to the well denoted with symbol “I”, in which the bead set 36 for specific binding to SARS-COV-2 is disposed. Similarly, the control circuit 23 controls two micro-valves 333 respectively correspond in position to two channels 324 that are in communication with two wells respectively denoted with symbols “B” and “II” such that the two micro-valves are switched to the open state and remaining ones of the micro-valves 333 are switched to the closed state, so as to allow the assay reagent 37 for detecting RdRp gene of SARS-COV-2 to flow (see a left one of dashed arrows in FIG. 11) from the well denoted with symbol “B” through the central recess portion 322 to the well denoted with symbol “II”, in which another bead set 36 for specific binding to SARS-COV-2 is disposed; the control circuit 23 controls two micro-valves 333 respectively correspond in position to two channels 324 that are in communication with two wells respectively denoted with symbols “C” and “III” such that the two micro-valves 333 are switched to the open state and remaining ones of the micro-valves 333 are switched to the closed state so as to allow the assay reagent 37 for detecting H1N1 gene of influenza A virus to flow (see a right one of solid arrows in FIG. 11) from the well denoted with symbol “C” through the central recess portion 322 to the well denoted with symbol “III”, in which the bead set 36 for specific binding to influenza A virus is disposed; the control circuit 23 controls two micro-valves 333 respectively correspond in position to two channels 324 that are in communication with two wells respectively denoted with symbols “D” and “IV” such that the two micro-valves 333 are switched to the open state and remaining ones of the micro-valves 333 are switched to the closed state so as to allow the assay reagent 37 for detecting M gene of influenza B virus to flow (see a right one of dashed arrows in FIG. 11) from the well denoted with symbol “D” through the central recess portion 322 to the well denoted with symbol “IV”, in which the bead set 36 for specific binding to influenza B virus is disposed. At the same time, the micro-pump 334 is controlled to reciprocate driving of flow of the assay reagents 37.

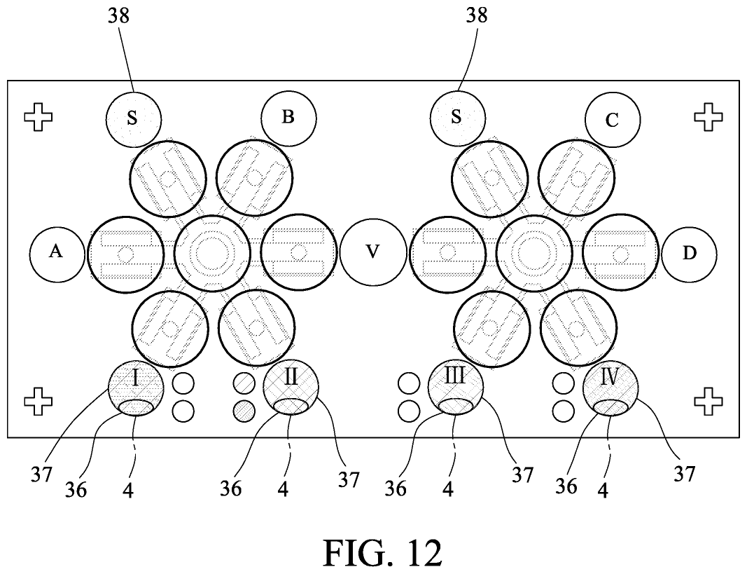

Furthermore, referring to FIG. 12, temperature control in the four of the wells respectively denoted with symbols “I”, “II”, “III” and “IV” for RT-PCR are conducted using the heating device 22.

Finally, the light detector 10 detects the fluorescent light emitted by the fluorescent dye in the assay reagents 37, and outputs a detection result based on the intensity of the fluorescent light. In this way, determination of whether a sample contains any one of SARS-COV-2, influenza A virus and influenza B virus can be made based on the detection result thus outputted.

It is worth to note that the microfluidic chip 3 is reusable by replacing old ones of the liquid channel layer 32 and the connecting layer 35 that have been used with new ones of the liquid channel layer 32 and the connecting layer 35 that have never been used.

Relationships between cycle threshold (Ct) values and concentrations of viruses for SARS-COV-2, influenza A virus and influenza B virus that are determined using the multiplex system 1 according to the disclosure are shown in Tables 3 and 4 below, wherein the Ct value is defined as a number of cycles of RT-PCR required for the fluorescent light generated during RT-PCR to exceed a preset threshold (which is a background level of fluorescence) so as to enable the light detector 10 to detect the fluorescent light. The smaller the Ct value is, the higher the concentration of the virus is. The multiplex system 1 according to the disclosure is capable of detecting E gene of SARS-COV-2 with a concentration as low as 2.2×10¹ particles/ml, RdRp gene of SARS-COV-2 with a concentration as low as 2.2×10¹ particles/ml, H1N1 gene of Influenza A with a concentration as low as 6.98×10¹ particles/ml, and M gene of Influenza B with a concentration as low as 1.55×10¹ particles/ml.

TABLE 3
SARS-COV-2

| E gene | | RdRp gene | |
|---|---|---|---|
| Concentration | | Concentration | |
| of virus | Cₜ | of virus | Cₜ |
| (particles/ml) | value | (particles/ml) | value |
| 2.2 × 10⁶ | 21.9 | 2.2 × 10⁶ | 21.9 |
| 2.2 × 10⁵ | 25.0 | 2.2 × 10⁵ | 23.9 |
| 2.2 × 10⁴ | 28.0 | 2.2 × 10⁴ | 25.9 |
| 2.2 × 10³ | 31.2 | 2.2 × 10³ | 28.9 |
| 2.2 × 10² | 34.0 | 2.2 × 10² | 31.9 |
| 2.2 × 10¹ | 36.9 | 2.2 × 10¹ | 33.9 |
| 0 | 38.5 | 0 | 38.2 |

TABLE 4

| Influenza A | | Influenza B | |
|---|---|---|---|
| (H1N1 gene) | | (M gene) | |
| Concentration | | Concentration | |
| of virus | Cₜ | of virus | Cₜ |
| (particles/ml) | value | (particles/ml) | value |
| 6.98 × 10⁶ | 22.9 | 5 × 10⁴ | 27.9 |
| 6.98 × 10⁵ | 22.9 | 3 × 10⁴ | 27.9 |
| 6.98 × 10⁴ | 25.9 | 1.55 × 10⁴ | 28.9 |
| 6.98 × 10³ | 32.9 | 1.55 × 10³ | 31.9 |
| 6.98 × 10² | 35.9 | 1.55 × 10² | 32.9 |
| 6.98 × 10¹ | 36.9 | 1.55 × 10¹ | 36.9 |
| 0 | 37 | 0 | 37 |

To sum up, in the multiplex system 1 according to the disclosure, the micro-valves 333 are controlled by the electromagnet array 21 to direct flows of the sample 4, the cleaning substance 38 and the at least two assay reagents 37 in the microfluidic chip 3, and temperature control in the microfluidic chip 3 for RT-PCR is conducted using the heating device 22, so as to achieve simultaneous detection of the at least two specific viruses possibly contained in a sample 4.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A multiplex system for simultaneously detecting at least two specific viruses possibly contained in a sample, said multiplex system comprising:
a control module including an electromagnet array that is configured to create a magnetic field; and
a microfluidics chip including
a substrate disposed on said control module,
a liquid channel layer disposed on said substrate and having at least one channel unit, said channel unit having a central recess portion and a plurality of microfluidics portions that extend radially from said central recess portion, each of said microfluidics portions having a channel that is in spatial communication with said central recess portion and that extends radially from said central recess portion, and a cavity that is in spatial communication with said channel and that is opposite to said central recess portion,
a flow-control layer disposed on said liquid channel layer, and having a plurality of upper through holes that are aligned respectively with said cavities of said liquid channel layer, a plurality of micro-valves that correspond in position to said channels respectively of said microfluidics portions, and a plurality of magnetic components that are respectively connected to said micro-valves, each of said micro-valves being switchable between a closed state where said micro-valve blocks the corresponding one of said channels, and an open state where said micro-valve allows fluid to flow from the corresponding one of said cavities to said central recess portion through the corresponding one of said channels, each of said upper through holes and the corresponding one of said cavities cooperatively forming a well, and
at least two bead sets that are respectively disposed in at least two of the wells respectively formed by said cavities, for each of said at least two bead sets, said bead set including a plurality of beads that are configured to be magnetically attracted to said electromagnet array such that the beads attach to the corresponding one of the wells and that are to be coated with the same aptamer for binding a target molecule of one of said at least two specific viruses possibly in the sample,
wherein at least one of those of the wells that do not receive said at least two bead sets is configured to receive the sample,
wherein said electromagnet array is configured to create a magnetic field for exerting a magnetic force on a desired group of said magnetic components such that the corresponding ones of said micro-valves are switched to the open state, so as to allow the sample to flow from the at least one of the wells, in which the sample is received, to the at least two of the wells, in which said at least two bead sets are disposed, and to allow the sample to be mixed respectively with said at least two bead sets.

2. The multiplex system as claimed in claim 1, wherein said electromagnet array is configured to create a magnetic field for exerting a pulling force on one of said magnetic components such that the corresponding one of said micro-valves are switched to the closed state, and to create a magnetic field for exerting a pushing force on one of said magnetic components such that the corresponding one of said micro-valves are switched to the open state.

3. The multiplex system as claimed in claim 1, wherein:
each of said microfluidics portions further has a groove formed in said liquid channel; and
each of said micro-valves is disposed between the corresponding one of said magnetic components and said liquid channel layer, and is fittingly disposed in said groove in the corresponding one of said channels when said micro-valve is in the closed state.

4. The multiplex system as claimed in claim 1, wherein said flow-control layer further includes a micro-pump corresponding in position to said central recess portion of said channel unit of said liquid channel layer, and another magnetic component connected to said micro-pump,
wherein said micro-pump is disposed between said another magnetic component and said liquid channel layer, and said electromagnet array is further configured to create a magnetic field for exerting a magnetic force on said another magnetic component such that said micro-pump reciprocate for driving flow of the sample.

5. The multiplex system as claimed in claim 1, wherein one of those of the wells that do not receive said at least two bead sets and the sample is configured to receive a cleaning substance for washing away residues of the sample that is not bound to said at least two bead sets.

6. The multiplex system as claimed in claim 1, wherein said control module further includes a heating device that is configured to perform thermal lysis to break viral envelopes of said at least two specific viruses possibly contained in the sample so as to release viral RNAs of said at least two specific viruses.

7. The multiplex system as claimed in claim 6, wherein said control module further includes a control circuit that is configured to control operations of said electromagnet array and said heating device.

8. The multiplex system as claimed in claim 1, wherein said microfluidics chip further includes a connecting layer that is disposed between said liquid channel layer and said flow-control layer, and that is formed with a plurality of lower through holes respectively corresponding in position to said cavities of said liquid channel layer,
wherein each of said lower through holes, the corresponding one of said upper through holes and the corresponding one of said cavities cooperatively form one of the wells.

9. The multiplex system as claimed in claim 1, wherein at least two of those of the wells that do not receive said at least two bead sets and the sample are configured to respectively receive at least two assay reagents for detecting said at least two specific viruses in the sample, respectively.

10. The multiplex system as claimed in claim 9, wherein each of said at least two assay reagents is a reverse transcription polymerase chain reaction (RT-PCR) assay reagent.

11. The multiplex system as claimed in claim 10, wherein, for each of said at least two assay reagents, the assay reagent contains a fluorescent dye, and when one of said at least two specific viruses in the sample is detected during RT-PCR, the fluorescent dye emits fluorescent light that corresponds to the one of said at least two specific viruses and that has an intensity related to an amount of the one of said at least two specific viruses.

12. The multiplex system as claimed in claim 11, further comprising:
a light detector disposed above said microfluidics chip, and configured to detect the fluorescent light emitted by the fluorescent dye, and to output, based on the intensity of the fluorescent light thus detected, a detection result indicating the amount of the one of said at least two specific viruses.

13. The multiplex system as claimed in claim 10, wherein:
said at least two assay reagents are configured to be used to detect severe acute respiratory syndrome-coronavirus 2 (SARS-COV-2);
one of said at least assay reagents contains primers having nucleotide sequences of SEQ ID NO: 4 and SEQ ID NO: 5 for detecting E gene of SARS-COV-2; and
the other of said at least two assay reagents contains primers having nucleotide sequences of SEQ ID NO: 6 and SEQ ID NO: 7 for detecting RdRp gene of SARS-COV-2.

14. The multiplex system as claimed in claim 10, wherein one of said at least two assay reagents is configured to be used to detect H1N1 gene of influenza A virus, and contains primers having nucleotide sequences of SEQ ID NO: 8 and SEQ ID NO: 9.

15. The multiplex system as claimed in claim 10, wherein one of said at least two assay reagents is configured to be used to detect M gene of influenza B virus, and contains primers having nucleotide sequences of SEQ ID NO: 10 and SEQ ID NO: 11.

16. The multiplex system as claimed in claim 1, wherein each of said at least two specific viruses is one of severe acute respiratory syndrome-coronavirus 2 (SARS-COV-2), influenza A virus and influenza B virus.

17. The multiplex system as claimed in claim 1, wherein said beads of one of said at least two bead sets are coated with a DNA aptamer having nucleotide sequences of SEQ ID NO: 1 which is capable of specifically binding to the spike protein of severe acute respiratory syndrome-coronavirus 2 (SARS-COV-2).

18. The multiplex system as claimed in claim 1, wherein said beads of one of said at least two bead sets are coated with a DNA aptamer having nucleotide sequences of SEQ ID NO: 2 which is capable of specifically binding to the target molecule of influenza A virus.

19. The multiplex system as claimed in claim 1, wherein said beads of one of said at least two bead sets are coated with a DNA aptamer having nucleotide sequences of SEQ ID NO: 3 which is capable of specifically binding to the target molecule of influenza B virus.

20. The multiplex system as claimed in claim 1, wherein:
said liquid channel layer has two channel units;
two cavities respectively of said two channel units are in spatial communication with each other; and
two upper through holes respectively corresponding in position to said two cavities are in spatial communication with each other.

21. An operation method of the multiplex system as claimed in claim 12, said control module further including a heating device, the operation method comprising steps of:
subjecting said electromagnet array to create a magnetic field such that all of said micro-valves are switched to the closed state;
disposing a cleaning substance in one of those of the wells that do not receive said at least two bead sets and said at least two assay reagents;
disposing the sample in one of those of the wells that do not receive said at least two bead sets, said at least two assay reagents and the cleaning substance;
subjecting said electromagnet array to create a magnetic field such that the corresponding ones of said micro-valves are switched to the open state, so as to allow the sample to flow from the one of the wells, in which the sample is received, to the at least two of the wells, in which said at least two bead sets are disposed, and to allow the sample to be mixed with said at least two bead sets;
subjecting said electromagnet array to create a magnetic field such that the corresponding one of said micro-valves are to switched to the open state, so as to allow the cleaning substance to flow from the one of the wells, in which the cleaning substance is received, to the at least two of the wells, in which said at least two bead sets are disposed, and to allow the cleaning substance to wash away residues of the sample that is not bound to said at least two bead sets;
subjecting said heating device to perform thermal lysis to break viral envelopes of said at least two specific viruses possibly contained in the sample so as to release viral RNAs of said at least two specific viruses;
subjecting said electromagnet array to create a magnetic field such that the corresponding ones of said micro-valves are switched to the open state to allow said at least two assay reagents to flow from the at least two of the wells, in which said at least two assay reagents are received, to the at least two of the wells, in which said at least two bead sets are disposed, and to allow said at least two assay reagents to be mixed with the viral RNAs that are possibly released;
subjecting said heating device to perform temperature control for RT-PCR; and
subjecting said light detector to detect the fluorescent light emitted by the fluorescent dye, and to output a detection result, accordingly.

22. The operation method as claimed in claim 21, said flow-control layer further including a micro-pump corresponding in position to said central recess portion of said channel unit of said liquid channel layer, and another magnetic component connected to said micro-pump, said micro-pump being disposed between said another magnetic component and said liquid channel layer, the operation method comprising a step of:
subjecting said electromagnet array to create a magnetic field for exerting a magnetic force on said another magnetic component such that said micro-pump reciprocates for driving flow of the sample.
